(19) United States
(12) Patent Application Publication
(10) Pub. No.: US 2014/0241509 A1
(43) Pub. Date: Aug. 28, 2014

(54) MESOPOROUS STRUCTURED MATERIAL, X-RAY WAVEGUIDE, AND METHOD OF FABRICATING MESOPOROUS STRUCTURED MATERIAL

(71) Applicant: CANON KABUSHIKI KAISHA, Tokyo (JP)

(72) Inventors: Shin Kitamura, Machida-shi (JP); Masahiko Takahashi, Hachioji-shi (JP); Hirokatsu Miyata, Hadano-shi (JP)

(73) Assignee: CANON KABUSHIKI KAISHA, Tokyo (JP)

(21) Appl. No.: 14/191,142

(22) Filed: Feb. 26, 2014

(30) Foreign Application Priority Data
Feb. 28, 2013 (JP) 2013-039269

(51) Int. Cl. G21K 1/06

(52) U.S. Cl. CPC G21K 1/062
USPC 378/145; 428/306.6; 428/141; 428/307.3; 427/331

(57) ABSTRACT

The invention provides a mesoporous structured material having a stacked structure, including a mesoporous structured material and a planarization layer existing on a surface of the mesoporous structured material.
wherein the mesoporous structured material consists of a mesoporous matrix having mesopores and a material existing in the mesopores,
the mesopores are exposed on a surface of the mesoporous matrix, and
the planarization layer is existing in the mesopores exposed on the surface of the mesoporous matrix.

### BACKGROUND OF THE INVENTION

1. Field of the Invention

The present invention relates to a mesoporous structured material, which can be applied as, for example, an optical material and a material for electronic devices, X-ray waveguide using the mesoporous structured material and a method of fabricating the mesoporous structured material.

2. Description of the Related Art

An X-ray waveguide disclosed in Physical Review B, Volume 62, p. 16939 (2000) consists of a cladding made of nickel and a core made of carbon. The waveguide has a stacked structure of elemental waveguides in which X-rays confined by total reflection at the interface between the cladding and the core propagate in the core. Thus, the waveguide can guide larger flux of X-rays in comparison with a waveguide (hereinafter, referred to as a monolayer waveguide) in which claddings and a core interposed therebetween are formed as a set.

However, the waveguide having such a configuration reduces advantages of monolayer waveguide such as phase alignment of the emitted X-rays, a light collection, and a dispersion inhibitory effect, since each elemental waveguide that consists of the stacked waveguides functions as a separate monolayer waveguide.

### SUMMARY OF THE INVENTION

Accordingly, a first aspect of the invention provides a mesoporous structured material having a stacked structure, consisting of a mesoporous structured material and a planarization layer existing on a surface of the mesoporous structured material.

In the first aspect, the mesoporous structured material includes a mesoporous matrix having mesopores and a material existing in the mesopores, the mesopores are exposed on a surface of the mesoporous matrix, and a root-mean-square surface roughness (rms) of an interface between the mesoporous structured material and the planarization layer is smaller than a diameter of mesopores which are not exposed on the surface of the mesoporous structured material.

In addition, a second aspect of the invention provides a method of fabricating a mesoporous structured material having a stacked structure, the method including:

forming a mesoporous structured material;

exposing mesopores on a surface of the mesoporous structured material; and

forming a planarization layer on the surface of the mesoporous structured material on which the mesopores are exposed.

Further features of the present invention will become apparent from the following description of exemplary embodiments (with reference to the attached drawings).

### BRIEF DESCRIPTION OF THE DRAWINGS

FIGS. 1A and 1B are cross-sectional views illustrating an example of a mesoporous structured material having a stacked structure of a first embodiment.

FIGS. 2A to 2F are diagrams illustrating an example of a method of fabricating the mesoporous structured material having the stacked structure of the first embodiment.

FIG. 3 is a diagram illustrating an example of an X-ray waveguide of a third embodiment.

FIGS. 4A and 4B are diagrams illustrating an electron microscope picture of a mesoporous structured material having a stacked structure of Example 1.

FIGS. 5A to 5F are diagrams illustrating an example of a method of fabricating an X-ray waveguide of Example 2.

FIGS. 6A to 6F are diagrams illustrating an example of a method of fabricating an X-ray waveguide of Example 3.

FIG. 7 is a diagram illustrating a valid propagation angle θ′ of the X-ray waveguide of the third embodiment.

### DESCRIPTION OF THE EMBODIMENTS

An example for implementing a mesoporous structured material of the invention will be described below.

### First Embodiment

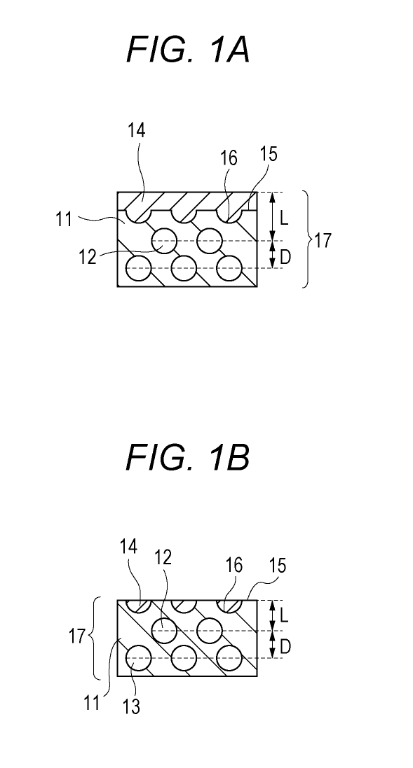

FIG. 1A is a schematic view of a cross section of a mesoporous structured material having a stacked structure according to the first embodiment when the mesoporous structured material is cut in a direction vertical to a main face of the mesoporous structured material having the stacked structure.

A mesoporous structured material 17 having a stacked structure according to the first embodiment includes a mesoporous matrix 11 which includes mesopores 12 and in which a root-mean-square surface roughness (rms) of at least a surface 15 is smaller than a diameter of the mesopore 12 of the mesoporous structured material, a material existing in the mesopore 12, and a planarization layer 14 existing on a surface of a mesopore 16 exposed on the surface of the mesoporous matrix 11.

The mesoporous matrix 11 includes the mesopores 12 having a pore diameter of 2 nm or more and 50 nm or less. Further, the mesopores 16 are exposed on the surface 15 of the mesoporous matrix 11. In addition, the surface 15 of the mesoporous matrix 11 is a surface in a film thickness direction of the mesoporous matrix, that is, a main face. Further, in the invention and the specification, the state in which “the pore is exposed on the surface of A” means that the pore exists on the surface of A and is different from a case where the pore does not exist on the surface of A but exists only in the inside of A. In addition, a material having the porous structure is classified according to a pore diameter by IUPAC (International Union of Pure and Applied Chemistry), and the porous material having the pore diameter of 2 nm or more and 50 nm or less is called mesoporous.

The material constituting the mesoporous matrix 11 is not particularly limited, but preferably includes an oxide in view of easiness of fabrication. Examples of the oxide may include silicon oxide, tin oxide, zirconium oxide, titanium oxide, niobium oxide, tantalum oxide, aluminum oxide, tungsten oxide, hafnium oxide, and zinc oxide. All of these materials have a refractive index real part of 0.999997 or less with respect to an X-ray of 10 keV, for example.

The mesoporous matrix 11 may be made of materials in which the oxide skeleton is substituted by an organic group, in addition to the above-described oxide.

The surface (including the surface 15) of the mesoporous matrix 11 may also be chemically modified as necessary. An example of the chemical modification may include a case where the surface of the mesoporous matrix is modified with hydrophobic molecules in order to suppress the adsorption of water.

The root-mean-square surface roughness (rms) of the surface 15 of the mesoporous matrix 11 is smaller than the diameter of the mesopore 12 which is not exposed on the surface 15 of the mesoporous matrix 11. In addition, the planarization layer 14 exists inside the mesopore 16 exposed on the surface 15 of the mesoporous matrix 11. Herein, root-mean-square surface roughness (rms) of the surface 15 of the mesoporous matrix 11 is estimated for a length of 10 micrometer or more. The rms value is the same as that was measured by atomic force microscopy prior to the formation of the planarization layer. The rms value can be estimated after the formation of the planarization layer by measuring the roughness of the interface between the surface of the mesoporous matrix and the planarization layer over a length of 10 micrometer in the plural cross-sectional electron micrographs of the interface.

The planarization layer 14 exists inside the mesopore 16, so that the surface 15 of the mesoporous structured material 17 having the stacked structure becomes a smooth surface on which the mesopore 16 is not exposed. The root-mean-square surface roughness (rms) of the “smooth surface” described herein is preferably 2.0 nm or less and more preferably 0.5 nm or less.

The planarization layer 14 uses an expression of “layer”, but may be a layer which continuously covers the surface 15 of the mesoporous matrix 11 as illustrated in FIG. 1A as long as the layer exists at least inside the mesopore 16. Moreover, as illustrated in FIG. 1B, the planarization layer 14 may be an aggregate of a plurality of discontinuously independent regions which are separated by regions located between the mesopores 16 exposed on the surface 15 of the mesoporous matrix 11.

The planarization layer 14 is not particularly limited, but may be made of inorganic substances, organic substances, and inorganic-organic composite materials. Examples of the inorganic substances may include oxides, light metals, and carbon. Among them, the oxides may be preferably used due to the fact that a rigid layer is easily formed by a coating and drying method and that adhesion property with the cladding is good in a case of forming an X-ray waveguide described in a third embodiment, in which the mesoporous structured material having the stacked structure according to the first embodiment is used as a core. Specific examples of the oxides may include oxides including Si, Al, Ti, Zn, Nb, Zr, or Sn.

The mesopore 12, which is not exposed on the surface 15, may have any one of a one-dimensional periodic structure, a two-dimensional periodic structure, and a three-dimensional periodic structure. When the mesopore 16 exposed on the surface 15 and the mesopore 12 not exposed on the surface 15 have the same period, the mesopore 16 exposed on the surface 15 may be arranged in any one of the one-dimensional periodic structure, the two-dimensional periodic structure, and the three-dimensional periodic structure. An example of the one-dimensional periodic structure may include a structure in which multiple layers are stacked. An example of the two-dimensional periodic structure may include a structure in which cylindrical structures are arrayed. An example of the three-dimensional periodic structure may include a structure in which cage structures are arrayed.

The material existing inside the mesopore 12 is formed of a different material from the material which forms the mesoporous matrix 11. Moreover, the concept of “the material existing inside the mesopore 12 is formed of a different material from the material which forms the mesoporous matrix 11” also includes a case where the material existing inside the mesopore 12 and the material which forms the mesoporous matrix 11 are common only in part. Preferably, the material existing inside the mesopore 12 has a refractive index real part of 0.999998 or more with respect to the X-ray of 10 keV and may include air and organic compounds, for example.

In addition, the material existing inside the mesopore 12 is not particularly limited as long as the organic compounds are used as a main material. The “main” described herein represents 50% or more in volume ratio.

Examples of the organic compounds may include amphiphilic substances. Examples of the amphiphilic substances may include ionic surfactants or nonionic surfactants. Examples of the ionic surfactants may include a halide salt of a trimethylalkylammonium ion. The chain length of the alkyl chain of the halide salt of the trimethylalkylammonium ion is preferably 10 or more and 22 or less in terms of a carbon number. Examples of the nonionic surfactant may include surfactants which contain polyethylene glycol as a hydrophilic group. Examples of the surfactants which contain polyethylene glycol as a hydrophilic group may include polyethylene glycol alkyl ether and a polyethylene glycol-polypropylene glycol-polyethylene glycol block copolymer. The chain length of the alkyl chain of the polyethylene glycol alkyl ether is preferably 10 or more and 22 or less in terms of a carbon number, the number of repetitions of the polypropylene glycol is preferably 10 or more and 100 or less, and the number of repetitions of the polyethylene glycol bonded to both sides of the polypropylene glycol chain is preferably 2 or more and 50 or less in total.

In addition, the material existing inside the mesopore 12 may be bonded to the material which forms the mesoporous matrix.

Further, in the invention and the specification, the mesoporous structured material represents a concept including both of a case where the mesopore is not hollow and is filled with materials as in the first embodiment and a case where the mesopore is hollow as in a second embodiment.

The mesoporous structured material 17 having the planarization layer 14 includes a periodic structured material including a region which is the mesoporous matrix 11 and a region made of a material which exists inside the mesopore 12 and is different from the material constituting the mesoporous matrix 11, and the planarization layer 14.

That is, the mesoporous structured material having the planarization layer according to the first embodiment includes the periodic structured material including the region made of a material having the refractive index real part of A and the region made of a material having the refractive index real part of B (which is different from A), and the planarization layer.

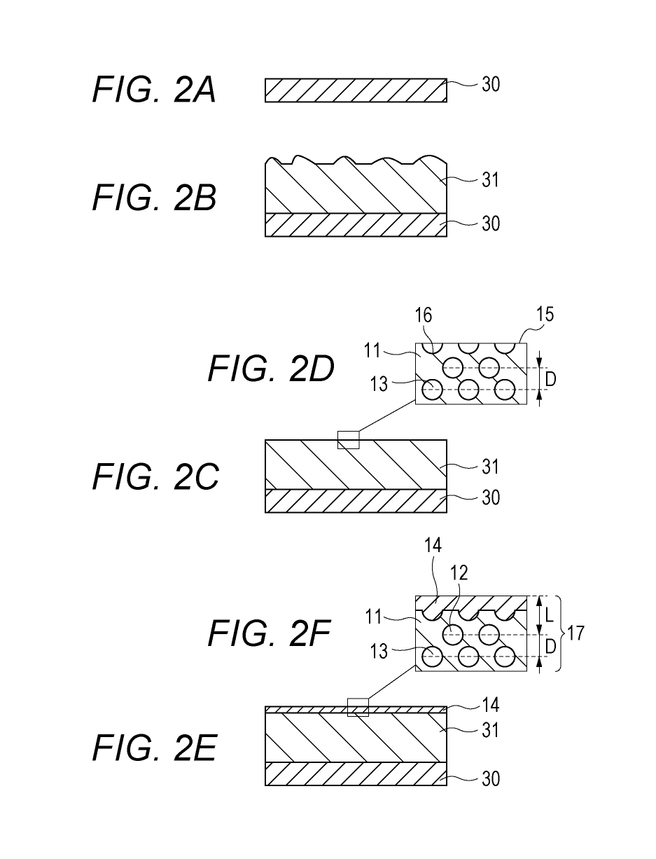

A method of fabricating the mesoporous structured material having the stacked structure according to the first embodiment will be described below with reference to FIGS. 2A to 2F.

The method of fabricating the mesoporous structured material having the stacked structure according to the first embodiment includes a process of forming the planarization layer on the surface of the mesoporous structured material having the mesopore in which the root-mean-square surface roughness (rms) of the surface is smaller than the diameter of the mesopore which is not exposed on the surface.

For example, the mesoporous structured material having the mesopore in which the root-mean-square surface roughness (rms) of the surface is smaller than the diameter of the mesopore which is not exposed on the surface can be obtained by the following processes.

(i) A process of fabricating a sol solution in which amphiphilic substances, inorganic oxide precursors, acid or base catalysts, water, and organic solvents are mixed.

(ii) A process of coating a substrate with the sol solution and drying the coated film to obtain the mesoporous structured material.

(iii) A process of removing a part of the surface of the mesoporous structured material to expose the mesopore.

(iv) A process of forming the planarization layer on the surface of the mesoporous structured material on which the mesopore is exposed.

Each process will be described below.

Process (i)

Examples of the inorganic oxide precursors may include alkoxides of silicon or metallic element and chlorides of silicon or metallic element. Specifically, examples of the inorganic oxide precursors may include alkoxides and chlorides of Si, Zr, Ti, Nb, Al, Zn, or Sn. Examples of the alkoxides may include methoxides, ethoxides, propoxides, and those which are partly substituted with an alkyl group.

The amphiphilic substance contained in the sol solution is not particularly limited, but is preferably surfactants. Examples of the surfactants may be cited as the examples of the materials existing inside the mesopore described above. The structural period of the mesoporous structured material obtained by the process (ii) can be changed by changing the number of repetitions of hydrophobic groups and hydrophilic groups of these surfactants. Generally, the pore diameter of the mesoporous structured material tends to increase as the molecular weight of the hydrophobic group and the hydrophilic group increases.

In addition, additives may be contained in the sol solution so as to adjust the structural period of a substance other than the amphiphilic substances. Examples of these additives may include alkoxysilanes with alkyl group, oligosiloxane compounds with alkyl group, alkanes, and hydrophobic substances such as an aromatic compound excluding the hydrophilic group. In the alkoxysilanes with alkyl group and the oligosiloxane compounds with alkyl group, examples of the chain length of an alkyl chain may be 10 to 22 in terms of a carbon number. Specific examples of the alkanes may be octane. The alkoxysilanes with alkyl group and the oligosiloxane compounds with alkyl group may be bonded to the inorganic oxide precursor at the time of adding.

Examples of the acid or base catalysts may include hydrochloric acid, sulfuric acid, and ammonium hydroxide.

Examples of the organic solvents may include alcohol series, ether series, and xylene.

Process (ii)

Examples of methods for coating the substrate with the sol solution may include a dip coat method, a spin coat method, and a hydrothermal synthesis method. Among these, the dip coat method is preferably used. Further, in the case of using the dip coat method, the coating speed is preferably 10 mm/s or less.

For example, the substrate may be those made of metals, metal oxides, organic compounds, and a composite material thereof. In addition, the substrate used herein is preferably a substrate which supports later the mesoporous structured material, indicated by a reference numeral 30 in FIGS. 2A, 2B, 2C and 2E.

A method of drying a coating film may employ a temperature under the coating environment and natural drying, but can also employ, for example, a constant temperature and humidity environment capable of controlling temperature and humidity. The optimum ranges (as a range to be frequently used, the temperature is 20° C. to 50° C. and the humidity is 30% to 60%) of the temperature and humidity are selected in consideration of the balance between the temperature and the humidity so as to set time required to dry the coating film to a desired value. In general, as the drying time is slow, it is unlikely to cause a variation in the periodic structure of the meso structured material, but the drying time is appropriately selected in combination with the time required for the fabrication and is preferably 2 to 50 hours.

The mesoporous structured material is obtained, in which the inorganic oxide precursor is changed into an inorganic oxide in a process where the solvent of the coating film is evaporated by the drying.

Here, the mesoporous structured material obtained by the drying of the coating film represents a structured material including the mesoporous matrix and amphiphilic substances existing in the mesopore provided on the mesoporous matrix.

The mesopore of the mesoporous matrix may contain water, the above-described organic solvent, and salt as necessary or according to materials to be used or a result of the process.

Process (iii)

As illustrated in FIG. 2B, a mesoporous structured material 31, in which the mesopore is not exposed on the main face (the largest face of faces on which the mesoporous matrix is formed), is formed on a substrate 30 by the processes (i) and (ii).

As illustrated in FIGS. 2C and 2D, the mesoporous structured material 31, in which the mesopore 16 is exposed on the surface 15, is obtained by partially removing the surface of the obtained mesoporous structured material 31. In addition, the mesopore 16 illustrated in FIG. 2D is exposed on the surface 15 in such a manner that a part of the main face of the mesoporous structured material is removed and thus a part of the mesoporous matrix, which is an outer wall for forming the mesopore, is removed. For this reason, the depth in a thickness direction of a recess portion, that is, the surface roughness of the surface of the mesoporous structured material 31 is smaller than the pore diameter of the mesopore 16. Accordingly, the root-mean-square surface roughness (rms) of the mesoporous structured material 31 in which the mesopore 16 is exposed on the surface 15 is often 2 nm or less although depending on the pore diameter of the mesopore 16.

As a method of removing a part of the mesoporous structured material 31, chemical etching or physical polishing can be used, for example. Examples of the chemical etching may include etching with a chemical solution which reacts chemically with the meso structured material and etching through a plasma treatment. Examples of the physical polishing may include mechanical polishing using a polishing agent. The method may use chemical-mechanical polishing (hereinafter, referred to as CMP) using the chemical solution and the polishing agent in combination. Further, a part of the surface of the mesoporous structured material 31 may be removed after a planarizing auxiliary layer is formed on the surface of the mesoporous structured material 31.

Process (iv)

Then, as illustrated in FIGS. 2E and 2F, the planarization layer 14 is formed on the surface 15 of the mesoporous structured material 31 in which the mesopore 16 is exposed on the surface 15. By forming the planarization layer 14, the mesopore 16 can be filled with the material forming the planarization layer 14 to reduce the unevenness on the surface 15 of the mesoporous structured material having the stacked structure.

The method of forming the planarization layer 14 may include a general sputtering method, a chemical vapor deposition (CVD) method, a vapor-deposition method, and a coating film forming method using solution. However, more preferably, the planarization layer 14 is formed by the coating and drying of the solution, for example, a spin-on-glass (hereinafter, referred to as SOG) method from the viewpoint of smoothing the surface of the mesoporous film.

For example, the planarization layer 14 made of Si oxide can be formed by the following formation method as the coating film forming method using solution.

The planarization layer 14 made of the Si oxide is obtained using the solution containing an Si oxide precursor and a solvent as the coating solution, that is, in such a manner that the coating solution is coated on the surface of the mesoporous matrix 11 on which the mesopore 16 is exposed using a coating method such as a spin coating method, a dip coat method and a spray method and that the solvent is dried. As the Si oxide precursor, for example, an inorganic-organic composite material such as an alkyl alkoxysilane, a siloxane, or an organosilsesquioxane as well as an inorganic material such as a tetraalkoxysilane or a perhydropolysilazane can be used. As the solvent, for example, alcohol series, ether series, or xylene can be used. A mixing ratio of the Si oxide precursor and the solvent is appropriately adjusted according to the thickness of the planarization layer 14 to be formed. The method of drying the solvent may include, for example, normal temperature and pressure drying, drying by heating, drying by baking, or drying under an inert gas atmosphere or reduced pressure in some cases.

In addition, it has been described herein that the planarization layer 14 is formed using, for example, the Si oxide, but the material for forming the planarization layer 14 is not limited to the Si oxide as described above. The planarization layer 14 can be formed in a similar manner even in a case of being made of other substances.

### Second Embodiment

A mesoporous structured material having a stacked structure according to a second embodiment is the mesoporous structured material having the stacked structure including the mesoporous matrix and the planarization layer existing on the surface of the mesoporous matrix, as described in the first embodiment. Others are the same as in the first embodiment.

For example, the mesoporous matrix according to the second embodiment can be obtained by a method of removing the amphiphilic substance existing inside the mesopore from the mesoporous structured material obtained by the processes (i) and (ii) described in the first embodiment. In this case, for example, the mesoporous matrix can be formed by performing the process of removing the amphiphilic substance existing inside the mesopore between the processes (ii) and (iii) described in the first embodiment.

Examples of the method of removing the amphiphilic substance from the mesoporous structured material may include baking, extraction, ultraviolet light irradiation, and an ozone treatment.

### Third Embodiment

An X-ray waveguide according to a third embodiment includes the mesoporous structured material having the planarization layer described in the first or second embodiment and two claddings which hold the mesoporous structured material having the planarization layer.

Here, in the third embodiment and the invention, the X-ray indicates an electromagnetic wave of a wavelength band in which the refractive index real part of the substance is 1 or less. Specifically, the X-ray indicates an electromagnetic wave having a wavelength of 100 nm or less, which includes extreme ultra violet (EUV) light. The electromagnetic wave, simply referred to below, is intended to indicate the X-ray described above.

Since a frequency of the X-ray is very high and the outermost shell electrons of the substance cannot respond, the X-ray has been known that the refractive index real part of the substance is smaller than 1, unlike a frequency band of the electromagnetic wave (visible light or infrared ray) having a wavelength which is not less than the wavelength of ultraviolet. The refractive index “n” of the substance with respect to the X-ray is expressed using a deviation amount δ from 1 of the real part and an imaginary part β′ related to the absorption as represented by the following formula (1).

n=1−δ−iβ′=n′−β′ [Formula 1]

Since the deviation amount δ is proportional to an electron density ρₑ of the substance, the real part of the refractive index becomes smaller as the electron density of the substance increases. The real part n′ of the refractive index is expressed by “1−δ”. The electron density ρₑ is proportional to an atom density ρₐ and an atomic number Z. Thus, the refractive index of the substance with respect to the X-ray is represented by a complex number. However, here, the real part is referred to as the refractive index real part or the real part of the refractive index and the imaginary part is referred to as a refractive index imaginary part or an imaginary part of the refractive index in the this invention and the third embodiment. When the X-ray propagates in a vacuum, the refractive index real part becomes maximum and the refractive index real part of air is maximized with respect to almost all substances which are not gas under a general environment. In addition, the vacuum is also described using a word “substance” in this specification.

l_{iεR}ε{obj, bkg}

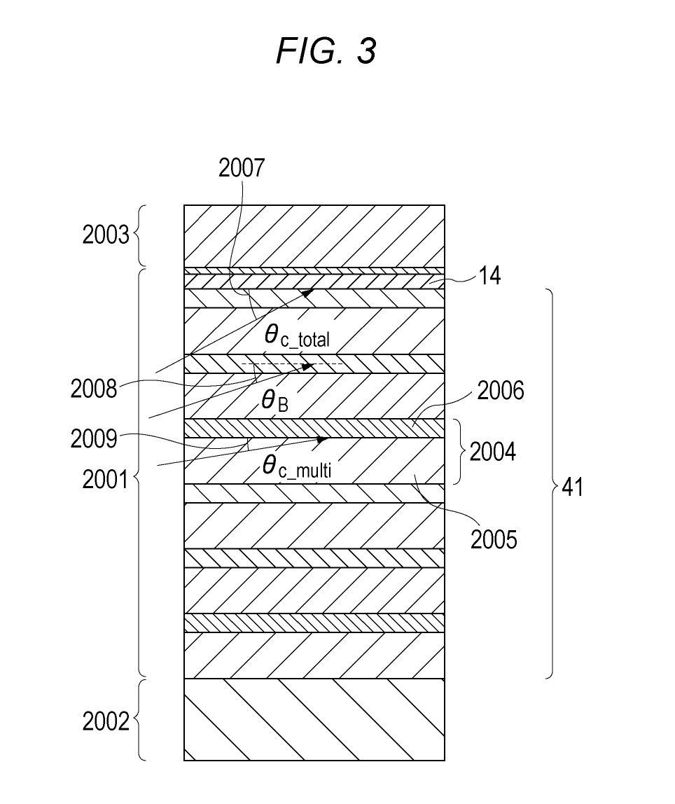

Next, an example of the X-ray waveguide according to the third embodiment and a method of fabricating the same will be described with reference to FIG. 3.

l_{iεR}ε{obj, bkg}

FIG. 3 illustrates the X-ray waveguide according to the third embodiment and a process where the X-ray waveguide according to the third embodiment expresses a periodic resonance waveguide mode.

The X-ray waveguide according to the third embodiment includes a mesoporous structured material 2001 of the stacked structure having the planarization layer 14 described in the first or second embodiment, the mesoporous structured material 2001 serving as a core, and claddings 2002 and 2003 which are disposed so as to sandwich the mesoporous structured material 2001 therebetween.

The mesoporous structured material 2001 having the stacked structure as the core may be any one of the one-dimensional periodic structure, the two-dimensional periodic structure, and the three-dimensional periodic structure as described in the first or second embodiment as long as it is the periodic structure of a meso region. In the description below, it is assumed that the mesoporous structured material as the core is a periodic structure stacked in a normal direction of the interface between the core and the cladding. In FIG. 3, layers 2005 and 2006 constitute the mesoporous structured material. One unit 2004 of the periodic structure includes both of the layers 2005 and 2006. A critical angle for total reflection θ_{c-total}, total 2007 is formed at the interface between the cladding and the mesoporous structured material. A critical angle for total reflection θ_{c-multi}2009 is formed at the interface between the layers constituting the mesoporous structured material which is a multilayer structure. A Bragg angle θ_{B} 2008 is formed due to periodicity of the multilayer structure. In addition, the planarization layer 14 exists between the mesoporous structured material 2001 having the stacked structure and the cladding 2003, but the thickness of the planarization layer 14 is very thin relative to the thickness of the structured material 2001 having the stacked structure. For this reason, the critical angle for total reflection θ_{c-total}2007 is calculated as a critical angle for total reflection at the interface between the cladding 2003 and the mesoporous structured material 2001. In addition, this angle shall be represented as 0° with respect to a direction parallel to a face of the film in this invention and the specification. Further, the arrows illustrated in FIG. 3 indicate traveling directions of the X-ray.

At the interface between the cladding 2003 and the mesoporous structured material 2001 having the stacked structure as the core, when a refractive index real part of the substance on the cladding side is represented by n_{clad} and a refractive index real part of the substance (layer 2006 in FIG. 3) on the side of the mesoporous structured material 2001 as the core is represented by n_{core}, the critical angle for total reflection θ_{c-total}(°) from the direction parallel to the film surface at the interface between the cladding 2003 and the mesoporous structured material 2001 having the stacked structure as the core is represented by the following Formula (2) on the condition that n_{clad} is smaller than n_{core} (n_{clad}<n_{core})

$${θ}_{c \text{-} total} = \frac{180}{π} arccos ( \frac{{n}_{clad}}{{n}_{core}} ) \qquad [ Formula 2 ]$$

When the period of the one-dimensional periodic structure of the mesoporous structured material 2001 having the stacked structure as the core is represented by “d” and the real part of the average refractive index of the core 2001 having the periodic structure is represented by n_{avg}, the Bragg angle θ_{B}(°) of the mesoporous structured material 2001 having the stacked structure as the core is approximately defined as represented by the following Formula (3) irrespective of the presence or absence of multiple diffraction inside the core 2001.

$${θ}_{B} \approx \frac{180}{π} arcsin ( \frac{1}{{n}_{avg}} m \frac{λ}{{2}_{d}} ) \qquad [ Formula 3 ]$$

Here, m represents a constant number, and λ represents the wavelength of the X-ray.

The X-ray waveguide according to the third embodiment is designed such that the refractive index of the cladding 2003 (the refractive index of the cladding 2002 is also equivalent to that of the cladding 2003), the refractive index of the layer 2006 provided in the mesoporous structured material 2001 having the stacked structure as the core, the distance between periods of the periodic structure provided in the mesoporous structured material 2001 having the stacked structure as the core, and the wavelength of the X-ray satisfy the following Formula (4).

θ_{B}<θ_{c-total} [Formula 4]

That is, the critical angle for total reflection at the interface between the core 2001 and the cladding 2003 is designed so as to be greater than the Bragg angle due to the periodicity of the periodic structure of the core 2001.

By satisfying the Formula (4), a waveguide mode having an effective propagation angle such as in the vicinity of the Bragg angle resulting from the periodicity of the core 2001 as the periodic structured material can be used to contribute to the propagation of the X-ray being always confined in the core 2001.

At this time, as for the X-ray waveguide of the embodiment, the core includes the mesoporous structured material 41 and the planarization layer 14 formed on the surface of the mesoporous structured material 41, so that the interface between the core 2001 and the cladding 2003 is smooth. Moreover, the incident X-ray is effectively confined in the core 2001 by the total reflection at the interface between the core and the cladding to express the periodic resonance waveguide mode. Thus, the X-ray waveguide according to the third embodiment guides the X-ray with high transmission efficiency.

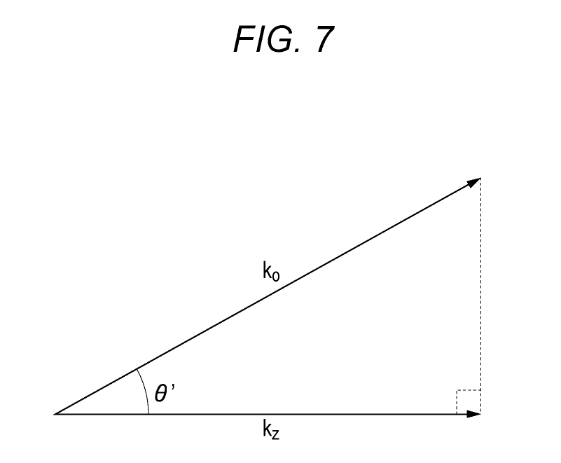

Here, an effective propagation angle θ′ (°) in this specification is represented by the following Formula (5) with a wave vector (propagation constant) k_{z} in a propagation direction of the waveguide mode and a wave vector k₀ in the vacuum. Since the k_{z} is constant at an interface between the respective layers by virtue of a continuous condition, as illustrated in FIG. 7, the effective propagation angle θ′ (°) represents an angle which is defined between the propagation constant k_{z} of the fundamental wave of the waveguide mode and the wave vector k₀ in the vacuum and at which the fundamental wave of the waveguide mode travels in the vacuum. Since the angle can be considered to approximately represent the propagation angle of the fundamental wave of the waveguide mode in the core 2001, the angle is used in the following description.

$${θ}^{′} = \frac{180}{π} arccos ( \frac{{k}_{z}}{{k}_{o}} ) \qquad [ Formula 5 ]$$

In this case, the mesoporous structured material of the core is assumed to be the multilayer structure in which the layers 2005 and 2006 having different real parts of the refractive index are periodically disposed in a direction from the core to the interface between the core and the cladding. At this time, the critical angle for total reflection is present due to a difference in real part of the refractive index between the respective layers constituting the core at an interface between adjacent films, as illustrated by reference numeral 2009 in FIG. 3 and is referred to as the θ_{c-multi}(°).

θ_{c}_{_{—}}ₘᵤₗₜᵢ<θ_{B} [Formula 6]

As represented in the above-described Formula (6), when the critical angle for total reflection at the interface between the respective layers inside the periodic structure of the core is smaller than the Bragg angle resulting from the periodicity of the periodic structure of the core, an X-ray incident on an interface in the multilayer structure at an angle equal to or larger than about the Bragg angle does not undergo the total reflection, but undergoes partial reflection or refraction. Since the multilayer structure has a structure in which a layer A made of a material “a” and a layer B made of a material “b” (the refractive index real part of the material “b” is different from that of the material “a”) are periodically disposed, multiple interfaces between the layer A and the layer B also exist in the direction from the center of the meso structured material to the surface, and the X-ray repeatedly undergoes reflection and refraction at these interfaces. Such repetition of the reflection and refraction of the X-ray in the multilayer structure causes multiple interferences. As a result, an X-ray having such a condition capable of resonating with the periodic structure of the core, that is, a propagation mode which can exist in the multilayer structure is formed. Thus, a waveguide mode is formed in the core of the X-ray waveguide. The mode is referred to as a “periodic resonance waveguide mode”.

Each of the periodic resonance waveguide modes has an effective propagation angle, and the effective propagation angle of the periodic resonance waveguide mode having the smallest effective propagation angle appears in the vicinity of the Bragg angle of the multilayer structure. Since the periodic resonance waveguide mode is a mode which resonates with the periodicity of the periodic structure, it is referred to as a “periodic resonance waveguide mode” in this specification. The mode corresponds to a propagation mode which satisfies the lowest-order band when the multilayer structure is considered as a one-dimensional photonic crystal having an infinite number of periods, and the propagation mode is confined by the total reflection at the interface between the cladding and the core.

Since the number of periods of an actual one-dimensional periodic structure is finite, its photonic band structure deviates from the photonic band structure of a one-dimensional periodic structure having an infinite period. However, waveguide mode characteristics approach those on a photonic band having an infinite period as the number of periods increases. In addition, the Bragg reflection is caused by an effect of a photonic band gap due to the periodicity, and the Bragg angle, which gives the Bragg reflection, is slightly larger than the effective propagation angle of the periodic resonance waveguide mode.

In the photonic band structure of the periodic structure, the waveguide mode which resonates with the periodic structure exists in an edge of the photonic band gap. When the effective propagation angle of the waveguide mode is considered on condition that the energy of the X-ray is constant, the waveguide mode having the relatively lower effective propagation angle out of those waveguide modes is a lowest-order periodic resonance waveguide mode. In a spatial distribution profile of the electric field intensity of the periodic resonance waveguide mode, the number of antinodes of the electric field intensity basically coincides with the number of periods of the multilayer film. The position of antinodes of a higher-order periodic resonance waveguide mode having the effective propagation angle corresponding to a higher-order Bragg angle basically becomes a natural number (2 or more) times of the number of periods.

In addition, a waveguide mode, which propagates at an angle other than the effective propagation angle of any such periodic resonance waveguide mode as described above, may also exist in a multilayer structure having the finite number of periods. Those modes are not periodic resonance waveguide modes, but are waveguide modes which exist when the entire multilayer structure as the core is considered as a uniform medium whose refractive index real part is averaged, and their characteristics are basically affected by the periodicity of the multilayer structure to a small extent. On the other hand, in a periodic resonance waveguide mode realized by the configuration of the X-ray waveguide, an electric field converges on the center of the core as the multilayer structure to a larger extent and the exuding into the cladding also decreases as the number of periods of the periodic structure increases. As a result, the propagation loss of the X-ray reduces. In addition, the envelope of an electric field intensity distribution is of a shape biased toward the center of the core, and hence a loss due to the exuding into the cladding reduces. Further, the phase of the periodic resonance waveguide mode to be used in the X-ray waveguide is matched in a direction in which the periodicity is high, in other words, in the direction vertical to the interface between the cladding and the core and to a guided wave direction, and hence can have spatial coherence. The phrase “the phase of the waveguide mode is matched” described herein refers not only to that a phase difference of electromagnetic field of an in-plane vertical to the guided wave direction is zero but also to that the phase difference of electromagnetic field periodically changes between −π and +π in correspondence with the spatial refractive index distribution of the periodic structure. The periodic resonance waveguide mode is such that the phase of an electric field changes between −π and +π at the same period as that of the periodic structure in the direction vertical to the guided wave direction.

As illustrated in FIGS. 1A and 1B, when the longitudinal direction of the mesopore 12 provided in the mesoporous structured material 2001 as the core is a direction parallel to the main face (film surface) of the mesoporous structured material, a distance L between the center of the mesopore 12, which is closest to the surface of the mesoporous matrix and is not exposed on the surface thereof, and the surface (in order words, the surface planarized by the planarization layer 14) of the mesoporous structured material 2001 is preferably a natural number times of a structural period D of the mesoporous structured material. This is because the electric field intensity of the periodic resonance waveguide mode is enhanced when the distance L is a natural number times of the structural period D of the meso structured material since the spatial distribution of the electric field intensity of the periodic resonance waveguide mode forms a constant period and the period is consistent with the structural period of the meso structured material. In addition, the distance L is more preferably the structural period D from the viewpoint of minimizing the loss of the periodic resonance waveguide mode in the planarization layer.

In addition, the planarization layer 14 may be formed using the composite materials of the inorganic substances and the organic substances or porous materials. Among these materials, the same materials as the layer 2006 of the mesoporous structured material or materials having the electron density in the range within ±50% of the average electron density of the materials forming the mesoporous matrix from the viewpoint of the loss of the waveguide mode are more preferably used. This is because the X-ray recognizes the substance by the difference of the electron density and causes the phenomenon of refraction and interference. The electron density is determined by an atomic number and an atomic density of the substance constituting the material.

Metals having a large electron density are used for the claddings 2002 and 2003. This is because the real part of the refractive index is smaller as the electron density of the substance increases. Examples of materials constituting the cladding may include a single unit of Os, Ir, Pt, Au, W, Ta, Hg, Ru, Rh, Pd, Pb, or Mo, and materials containing these elements.

The claddings 2002 and 2003 vary depending on the materials, but are required to be thick enough to sufficiently confine the X-ray in the core and to be as thin as possible in terms of cost and fabrication. The thickness of the claddings is, for example, 1 nm or more and 300 nm or less, and is preferably 1 nm or more and 50 nm or less. The claddings can be formed by the sputtering method or the vapor-deposition method.

The thickness of the claddings may have a distribution in the X-ray waveguide. For example, the claddings can be formed to be thin in an incident region of the X-ray, and the claddings can be formed to be thick in other regions. In such a case where the claddings of the incident region are formed to be thin, introduction efficiency is improved to actively perform the incidence from the surface of the claddings, and a confinement effect of the X-ray can be increased in such a case where the claddings of the regions other than the incident region are formed to be thick.

### EXAMPLES

Hereinafter, the examples of the invention will be described in detail, but the method of the invention is not limited to these examples.

### Example 1

An example of forming a mesoporous structured material, which is made of silica and has a stacked structure, on a substrate will be described.

Hereinbelow, the example will be described with reference to FIGS. 2A to 2F.

(1-1) Formation of Mesoporous Structured Material

(Preparation of Precursor Solution for Mesoporous Structured Material)

A mesoporous structured material 31 of silicon oxide having a 2D hexagonal structure formed of a cylindrical mesopore was prepared by a dip coating method. The precursor solution of the mesoporous structured material was prepared by adding an ethanol solution of block polymer to a solution in which ethanol, 0.01 M hydrochloric acid, and tetraethoxysilane were mixed for 20 minutes and by stirring the mixture for 3 hours. As the block polymer, ethylene oxide (20) propylene oxide (70) ethylene oxide (20) (hereinafter, represented as EO(20)PO(70)EO(20) (here, numbers in parentheses represent the number of repetitions of the respective blocks)) was used. A mixing ratio (molar ratio) of “tetraethoxysilane:hydrochloric acid:water:ethanol:block polymer:ethanol” was set to 1.0:0.0011:6.1:5.2:0.0096:3.5. The solution was appropriately diluted before use, for the purpose of adjusting a film thickness.

(Formation of Mesoporous Structured Material)

A washed substrate was subjected to dip-coating with a dip coating apparatus at a lifting velocity of 0.5 mms⁻¹. After forming a film by the dip-coating, the film was maintained in a thermo-hygrostat of 25° C. and relative humidity of 40% for 2 weeks and maintained at 80° C. for 24 hours so that the mesoporous structured material was formed. From X-ray diffraction analysis using a Bragg-Brentano arrangement with respect to the adjusted mesoporous structured material, it was confirmed that the mesoporous structured material had high order in the normal direction of the substrate surface and that an interlayer spacing, that is, the period in a confinement direction was 10 nm and the film thickness was approximately 500 nm. As described above, the mesoporous structured material has the cylindrical mesopores arranged in two-dimensional structure and a periodic structure formed in a film thickness direction. In the mesoporous structured material of this example, block polymer as a template remains in the matrix mesopore.

(1-2) Polishing

By subsequently polishing the surface of the formed mesoporous structured material, the mesopore is exposed on the surface of the mesoporous structured material. The polishing was performed by a CMP apparatus (manufactured by MAT Inc.) with the polishing solution manufactured by BUEHLER in which colloidal silica particles having a diameter of 30 nmΦ were dispersed. The film thickness of about 200 nm was removed through this process by adjusting the polishing time in the polishing. When viewing a cross section of the formed substrate with an electron microscope, the mesoporous structured material was planarized macroscopically, but the unevenness of nano-order due to the meso-structure was present on the surface and the root-mean-square surface roughness (rms) thereof was 2 nm (see FIGS. 2C and 2D).

(1-3) Formation of Planarization Layer

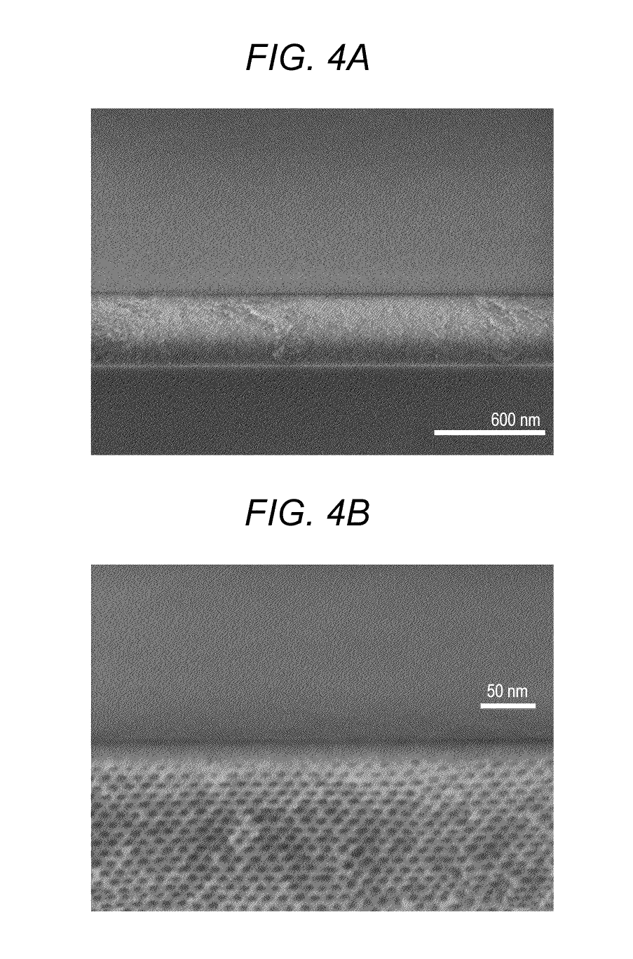

A planarization layer 14, which is formed to smooth the unevenness caused by the mesoporous structured material, was formed by a spin coating of SOG. In SOG, a NAX120 manufactured by AZ Electronic Materials Co., which was diluted with dibutyl ether to 2%, was spin-coated onto the substrate. The coated substrate was maintained in the thermo-hygrostat of 25° C. and relative humidity of 40% for hours. The NAX120 becomes high purity silica after dibutyl ether is dried by hydrolysis with moisture present in the atmosphere. According to this process, the planarization layer 14 made of silica was formed so as to fill recess portions caused by the mesoporous structure (see FIGS. 2E and 2F) and the root-mean-square surface roughness (rms) thereof was 0.34 nm. FIGS. 4A and 4B are diagrams illustrating an electron microscope picture of the mesoporous structured material having the stacked structure fabricated by this example. The mesoporous structured material had a periodic structure in the film thickness direction in which cylindrical mesopores were arranged two-dimensionally. In FIGS. 1A and 1B, a distance L (a distance L from the center of the mesopore 12, which is closest to the surface of the mesoporous matrix and is not exposed on the surface, to the surface of the mesoporous structured material (in other words, the surface planarized by the planarization layer 14)) was 30 nm, corresponding to three times the structural period of 10 nm of the mesoporous structured material.

### Example 2

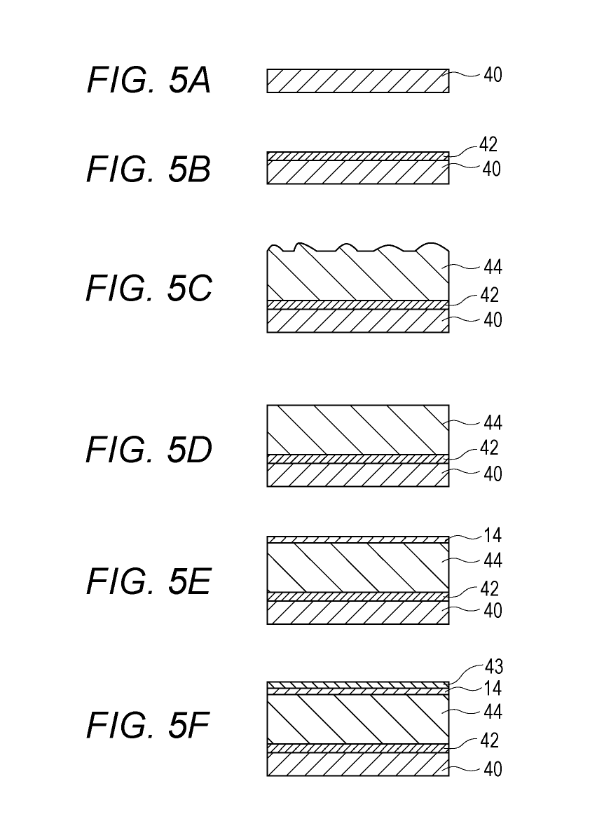

This example describes a method of fabricating an X-ray waveguide having a mesoporous structured material with a stacked structure with reference to FIGS. 5A to 5F. The X-ray waveguide according to this example is formed of a cladding 42 made of tungsten (W), a core including a mesoporous structured material 44 and a planarization layer 14, and a cladding 43, on an Si substrate 40.

(2-1) Formation of Cladding (See FIG. 5B)

The cladding 42 made of tungsten is formed by a sputtering method on the Si substrate so as to have a thickness of approximately 15 nm.

(2-2) Formation of Mesoporous Structured Material (See FIG. 5C)

A mesoporous structured material having a cylindrical mesopore is formed on the cladding 42 using the same method as in the process (1-1).

(2-3) Polishing (See FIG. 5D)

The surface of the mesoporous structured material is removed partially using the same method as in the process (1-2).

(2-4) Formation of Planarization Layer (See FIG. 5E)

A mesoporous silica structured material was planarized using the same method as in the process (1-3), except that only dilution degree by dibutyl ether was changed to 0.3%. According to this process, the planarization layer 14 made of silica was formed so as to fill a recess portion caused by the mesopore as illustrated in FIG. 1A, and the root-mean-square surface roughness (rms) thereof was 1.0 nm. In FIGS. 1A and 1B, a distance L (a distance from the center of the mesopore 12 located at the top of the mesoporous film to the surface planarized by the planarization layer 14 made of silica) is 10 nm, corresponding to the same value as a structural period 10 nm of the mesoporous structured material.

(2-5) Formation of Cladding (See FIG. 5F)

A cladding 43 made of tungsten is formed on the planarization layer 14. The cladding is formed by the sputtering method so as to have a film thickness of 15 nm.

(2-6) Relation Between X-Ray Reflectance and Surface Roughness

The surface roughness is evaluated using a surface roughness meter. The surface roughness of the mesoporous silica film formed in the process (2-2) is about nm in terms of rms, the surface roughness of the mesoporous silica structured material polished in the process (2-3) is about 2 nm in terms of rms, and the surface roughness of the mesoporous structured material planarized in the process (2-4) is about 1 nm in terms of rms.

The comparative evaluation of reflectance is performed when irradiating the cladding of the X-ray waveguide with the X-ray. The X-ray reflectance is measured when the X-ray is incident at the angle (θ=0.30°: within a total reflection region of the cladding) which deviates from the Bragg reflection in the vicinity of Bragg angle (θ=0.36° corresponding to the periodic structure of the core using the X-ray of 10 keV.

The X-ray waveguide of Example 2 exhibits an X-ray reflectance of about three times that of the X-ray waveguide in which the processes (2-3) and (2-4) are not performed, the planarization layer is not formed, and the polishing is not performed. This suggests that the confinement effect of the X-ray due to the cladding of the X-ray waveguide is improved by the formation of the planarization layer.

(2-7) Guiding Characteristics

The X-ray of 10 keV is incident on the waveguide, and the intensity of the X-ray guided by the periodic resonance waveguide mode is measured. Consequently, the wave guiding strength of approximately ten times is observed as compared with that of the X-ray waveguide in which the processes (2-3) and (2-4) are not performed, the planarization layer is not formed, and the polishing is not performed. It is considered that the confinement efficiency of the X-ray is improved by good smoothness at the interface between the core and the cladding of the x-ray waveguide, so that the higher wave guiding strength is achieved.

### Example 3

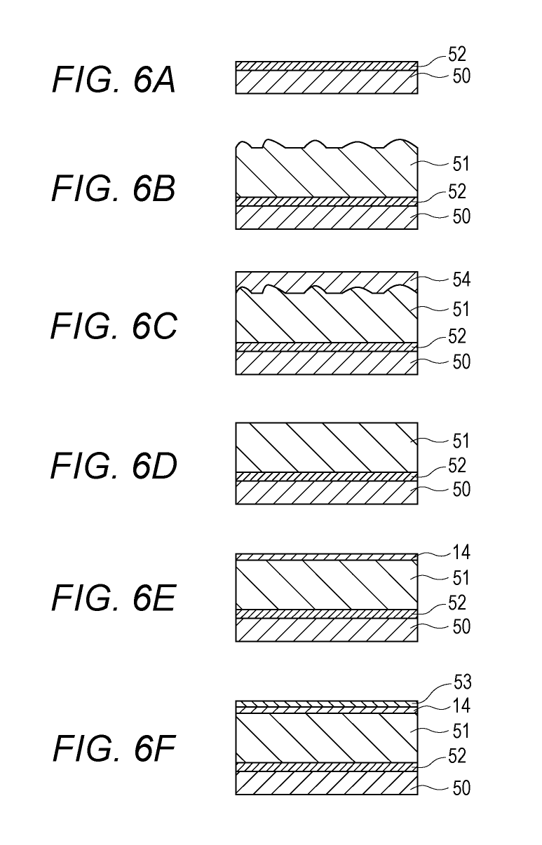

This example describes an X-ray waveguide having a mesoporous structured material with a stacked structure with reference to FIGS. 6A to 6F. The X-ray waveguide according to this example is formed of a cladding 52 made of tungsten, a core including a mesoporous structured material 51 made of silica and a planarization layer 14, and a cladding 53, on an Si substrate 50. The configuration of the waveguide is the same as in Example 2, except that a fabrication method is partially different from that of Example 2.

(3-1) Formation of Cladding (See FIG. 6A)

The cladding 52 is formed using the same method as in the process (2-1).

(3-2) Formation of Mesoporous Structured Material (See FIG. 6B)

The mesoporous structured material made of silica is formed on the cladding 52 using the same method as in the process (1-1).

(3-3) Formation of Planarization Layer (See FIG. 6C)

A planarizing auxiliary layer 54 for planarizing a surface unevenness of the formed mesoporous structured material is formed. The planarizing auxiliary layer 54 was formed by the spin coating of the SOG. As SOG materials, a NAX120 of AZ Electronic Materials Co., which was diluted with dibutyl ether to 20%, was coated onto the substrate by the spin-coating method. The coated substrate is maintained in the thermo-hygrostat of 25° C. and relative humidity of 40% for 24 hours and then the planarizing auxiliary layer 54 having a film thickness of 300 nm is formed.

(3-4) Polishing

Next, the planarizing auxiliary layer is subjected to etching back. Using a dry etching apparatus, sputter etching is performed to the vicinity of the interface between the mesoporous structured material 51 and the planarizing auxiliary layer 54 with Ar gas plasma. The surface roughness of the mesoporous structured material made of silica after this process is 2.5 nm in terms of rms.

(3-5) Planarization Treatment (See FIG. 6E)

The planarization layer is formed on the mesoporous structured material made of silica using the same method as in the process (1-3). The surface roughness of the mesoporous structured material made of silica according to this process is 0.34 nm in terms of rms, and a distance L illustrated in FIGS. 1A and 1B is 30 nm, corresponding to three times the structural period of 10 nm of the mesoporous structured material made of silica.

(3-6) Formation of Cladding (See FIG. 6F)

The cladding 53 made of tungsten is formed on the mesoporous structured material 51 made of silica. The cladding is formed by the sputtering method so as to have a film thickness of 15 nm.

(3-7) X-Ray Reflectance

When measuring the X-ray reflectance in the same manner as in the process (2-6) of Example 2, the X-ray waveguide of Example 3 exhibits a value of approximately five times the reflectance of the X-ray waveguide using a mesoporous silica structured material made of silica as a core, in which the processes (3-3) and (2-4) are not performed, the polishing is not performed, and the planarization layer is not formed. This suggests that the confinement effect of X-ray by the interface between the cladding and the core of the X-ray waveguide is improved due to the formation of the planarization layer and the polishing.

(3-8) Guiding Characteristics

When measuring the X-ray wave guiding intensity by way of the process (2-7) of Example 2, it is measured that the X-ray waveguide of Example 3 has wave guiding intensity of approximately 12 times as compared to the X-ray waveguide, in which the processes (3-3) to (3-5) are not performed, the planarization layer is not formed, and the polishing is not performed. It is considered that the confinement efficiency of the X-ray is improved by the good smoothness at the interface between the core and the cladding of the X-ray waveguide, so that the higher wave guiding strength is achieved.

### Example 4

This example describes an X-ray waveguide having a mesoporous structured material with a stacked structure with reference to FIGS. 5A to 5F. The X-ray waveguide according to this example is formed of a cladding 42 made of tungsten, a core including a mesoporous structured material 44 made of silica and a planarization layer 14 made of mesoporous silica, and a cladding 43, on an Si substrate 40.

(4-1) Formation of Cladding and Core and Planarization of Core (See FIGS. 5A to 5D)

The cladding 42 and the mesoporous structured material 44 are formed on the substrate using the same method as in the processes (2-1) to (2-3) in Example 2, and the polishing of the mesoporous structured material 44 and the formation of the planarization layer are performed.

(4-2) Formation of Planarization Layer (See FIG. 5E)

(4-2-1) Preparation of Precursor Solution of Mesoporous Structured Material Made of Silica

The planarization layer 14 is prepared using the dip coating method. The precursor solution of mesoporous silica is prepared by mixing tetraalkoxysilane 2.6 g, block copolymers (Pluronic P123 manufactured by BASF Corp.) 0.7 g, 1-propanol 13 g, and 0.01 M hydrochloric acid solution 1.35 g and by stirring them.

(4-2-2) Formation of Mesoporous Silica Film

The washed substrate is dip-coated at a lifting velocity of 0.5 mms⁻¹ by using a dip coating apparatus with the prepared precursor solution which is further diluted with 1-propanol by five times. After forming a film by the dip-coating, the film is maintained in a thermo-hygrostat of 25° C. and relative humidity of 40% for 2 weeks and maintained at 80° C. for 24 hours. A mesoporous silica film, which is formed as a planarization layer to reduce the unevenness, has a structure in which periodicity is inferior to that of the structure formed in the core (during the film formation, the smoothness is improved by giving a distribution to the periodicity of the structure.).

By this process, the mesoporous silica film is formed as a discontinuous planarization layer which fills the mesopores exposed on the surface as illustrated in FIG. 1B, and the root-mean-square surface roughness (rms) of the surface is 0.5 nm.

The surface of the mesoporous silica film formed by this process is in a state that mesopores are not exposed but covered with the silica wall. The distance L in FIGS. 1A and 1B is 30 nm, corresponding to three times the structural period of the mesoporous structured material made of silica.

(4-3) X-Ray Reflectance

When measuring the X-ray reflectance in the same manner as the process (2-6) of Example 2, the X-ray waveguide of Example 4 exhibits a value of approximately four times the reflectance of the X-ray waveguide using a mesoporous structured material made of silica as a core and not having the planarization layer. It is thus suggested that the surface of the mesoporous structured material is planarized and therefore the confinement effect of the X-ray by the interface between the cladding and the core of the x-ray waveguide is improved.

(4-4) Guiding Characteristics

When measuring the X-ray wave guiding intensity in the same manner as the process (2-7) of Example 2, it is measured that the X-ray waveguide of Example 4 has a wave guiding intensity of approximately 12 times as compared to the X-ray waveguide not having the planarization layer. It is considered that the confinement efficiency of the X-ray is improved by the good smoothness at the interface between the core and the cladding of the X-ray waveguide, so that the higher wave guiding strength is achieved.

According to an embodiment of the invention, it is possible to obtain the mesoporous structured material having the stacked structure with the smooth surface, which can be applied to optical devices, electronic devices, and X-ray devices. In addition, according to an embodiment of the invention, it is possible to increase the confinement effect of the X-ray by the smooth interface between the core and the cladding to obtain the X-ray waveguide which can guide the X-ray in which the phase is aligned with higher transmission efficiency.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-039269, filed Feb. 28, 2013, which is hereby incorporated by reference herein in its entirety.

What is claimed is:

1. A mesoporous structured material having a stacked structure, comprising:
a mesoporous structured material; and
a planarization layer existing on a surface of the mesoporous structured material,
wherein the mesoporous structured material consists of a mesoporous matrix having mesopores and a material existing in the mesopores,
the mesopores are exposed on a surface of the mesoporous matrix, and
the planarization layer is existing in the mesopores exposed on the surface of the mesoporous matrix.

2. The mesoporous structured material having a stacked structure according to claim 1, wherein the mesopores exposed on the surface of the mesoporous matrix are periodically formed.

3. The mesoporous structured material having a stacked structure according to claim 1, wherein a root-mean-square surface roughness (rms) of an interface between the mesoporous structured material and the planarization layer is smaller than a diameter of the mesopores which are not exposed on the surface of the mesoporous structured material.

4. The mesoporous structured material having a stacked structure according to claim 1, wherein the planarization layer is an aggregate of a plurality of independent regions which are separated by the mesoporous matrix.

5. The mesoporous structured material having a stacked structure according to claim 1, wherein the planarization layer is a continuous layer.

6. The mesoporous structured material having a stacked structure according to claim 1, wherein the material existing in the mesopores is air.

7. The mesoporous structured material having a stacked structure according to claim 1, wherein the material existing in the mesopores includes an organic compound.

8. The mesoporous structured material having a stacked structure according to claim 1, wherein the mesopores are formed in a cylindrical shape.

9. The mesoporous structured material having a stacked structure according to claim 1, wherein a distance L between a center of a mesopore which is not exposed on the surface of the mesoporous matrix and is closest to the surface, among the mesopores provided in the mesoporous matrix, and a surface of the planarization layer is a natural number times of a structural period D of the mesoporous structured material.

10. The mesoporous structured material having a stacked structure according to claim 9, wherein the distance L is the structural period D of the mesoporous matrix.

11. The mesoporous structured material having a stacked structure according to claim 1, wherein the mesoporous matrix consists of silica.

12. The mesoporous structured material having a stacked structure according to claim 1, wherein a material forming the planarization layer is the same as a material forming the mesoporous matrix.

13. The mesoporous structured material having a stacked structure according to claim 1, wherein a material forming the planarization layer is a material having an electron density in a range within ±50% of an average electron density of the mesoporous structured material.

14. The mesoporous structured material having a stacked structure according to claim 1, wherein a root-mean-square surface roughness (rms) of a surface of the planarization layer is smaller than a diameter of the mesopores of the mesoporous structured material.

15. The mesoporous structured material having a stacked structure according to claim 14, wherein the root-mean-square surface roughness (rms) of the surface of the planarization layer is 2.0 nm or less.

16. The mesoporous structured material having a stacked structure according to claim 14, wherein the root-mean-square surface roughness (rms) of the surface of the planarization layer is 0.5 nm or less.

17. An X-ray waveguide comprising:
a core; and
two claddings which hold the core therebetween,
wherein the core is the mesoporous structured material having a stacked structure according to claim 1, and
a critical angle for total reflection at an interface between the cladding and the core is larger than a Bragg angle corresponding to a periodicity of the core.

18. The X-ray waveguide according to claim 17, wherein the cladding has a stacked structure of multiple layers.

19. A method of fabricating a mesoporous structured material having a stacked structure, the method comprising:
forming a mesoporous matrix;
exposing the mesopores on a surface of the mesoporous matrix; and
forming a planarization layer on the surface of the mesoporous matrix on which the mesopores are exposed.

20. The method of fabricating a mesoporous structured material having a stacked structure according to claim 19, wherein the exposing the mesopores on the surface of the mesoporous matrix includes partially removing the surface of the mesoporous matrix and making a root-mean-square surface roughness (rms) of the surface of the mesoporous matrix smaller than a diameter of the mesopores in the mesoporous matrix which are not exposed on the surface.

21. The method of fabricating a mesoporous structured material having a stacked structure according to claim 19, wherein the forming the planarization layer on the surface includes forming the planarization layer to cover the mesopores.
